(19) United States
(12) Patent Application Publication
(10) Pub. No.: US 2026/0253046 A1
(43) Pub. Date: Aug. 27, 2026

(54) SOCIAL NETWORK-BASED METAVERSE INTEGRATIONS

(71) Applicant: International Business Machines Corporation, Armonk, NY (US)

(72) Inventors: Carolina Garcia Delgado, Zapopan (MX); Sarbajit Kumar Rakshit, Kolkata (MX); Michael Boone, Lutz, FL (US); Tushar Agrawal, West Fargo, ND (US)

(21) Appl. No.: 19/063,217

(22) Filed: Feb. 25, 2025

(51) Int. Cl. G06Q 10/40; G06F 3/04815; G06T 19/00

(52) U.S. Cl. CPC G06Q 10/40; G06F 3/04815; G06T 19/006

(57) ABSTRACT

Techniques are described with respect to a system, method, and computer product for sharing social media-based virtual environment collaboration. An associated method includes analyzing a virtual environment; determining a plurality of contextual information and a secure social-media zoning associated with the virtual environment based on the analysis; and presenting the virtual environment to a social media network associated with a user based on the secure social-media zoning; wherein the secure social-media zoning comprises an audience comprising a derivative of the social media network.

### BACKGROUND

This disclosure relates generally to the field of virtual, augmented, extended and/or mixed reality systems, and more particularly to social network-based integrations within virtual, augmented, extended and/or mixed reality systems.

Within the metaverse or any virtual, augmented, extended, and/or mixed reality-based environment, avatars are able to gather within a given virtual environment resulting in communication, collaboration, and the like. In particular, social network and/or social media platforms have become integrated into virtual environments allowing users to interact and share content from the aforementioned platforms with fellow friends, family, colleagues, etc.

### SUMMARY

Additional aspects and/or advantages will be set forth in part in the description which follows and, in part, will be apparent from the description, or may be learned by practice of the invention.

A system, method, and computer program product for sharing virtual environment collaboration is disclosed herein. In some embodiments, a computer-implemented method for sharing virtual environment collaboration comprises analyzing a virtual environment; determining a plurality of contextual information and a secure social-media zoning associated with the virtual environment based on the analysis; and presenting the virtual environment to a social media network associated with a user based on the secure social-media zoning; wherein the secure social-media zoning comprises an audience comprising a derivative of the social media network.

### BRIEF DESCRIPTION OF THE DRAWINGS

These and other objects, features and advantages will become apparent from the following detailed description of illustrative embodiments, which is to be read in connection with the accompanying drawings. The various features of the drawings are not to scale as the illustrations are for clarity in facilitating the understanding of one skilled in the art in conjunction with the detailed description. In the drawings:

FIG. 1 illustrates a networked computer environment, according to an exemplary embodiment;

FIG. 2 illustrates a block diagram of a social network-based collaboration sharing environment, according to an exemplary embodiment;

FIG. 3 illustrates a block diagram of various modules associated with the social network-based collaboration sharing system of FIG. 2, according to an exemplary embodiment;

FIG. 4 illustrates a viewpoint of an augmented reality user viewing distinct virtual events provided by two separate social network platforms, according to an exemplary embodiment;

FIG. 5 illustrates two secure social-media zonings generated based on analyses of two separate social network platforms and defined constraints, according to an exemplary embodiment; and

FIG. 6 illustrates an exemplary flowchart depicting a method for sharing social media-based virtual environment collaborations, according to an exemplary embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. Those structures and methods may, however, be embodied in many different forms and should not be construed as limited to the exemplary embodiments set forth herein. Rather, these exemplary embodiments are provided so that this disclosure will be thorough and complete and will fully convey the scope to those skilled in the art. In the description, details of well-known features and techniques may be omitted to avoid unnecessarily obscuring the presented embodiments.

The terms and words used in the following description and claims are not limited to the bibliographical meanings, but are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

It should be understood that the Figures are merely schematic and are not drawn to scale. It should also be understood that the same reference numerals are used throughout the Figures to indicate the same or similar parts.

In the context of the present application, where embodiments of the present invention constitute a method, it should be understood that such a method is a process for execution by a computer, i.e. is a computer-implementable method. The various steps of the method therefore reflect various parts of a computer program, e.g. various parts of one or more algorithms.

Also, in the context of the present application, a system may be a single device or a collection of distributed devices that are adapted to execute one or more embodiments of the methods of the present invention. For instance, a system may be a personal computer (PC), a server or a collection of PCs and/or servers connected via a network such as a local area network, the Internet and so on to cooperatively execute at least one embodiment of the methods of the present invention.

The following described exemplary embodiments provide a method, computer system, and computer program product for sharing social media-based virtual environment collaborations.

The convergence of social networks and Augmented Reality/Virtual Reality /Mixed Reality/Extended Reality-based collaborations represents transformative means in how individuals engage in shared experiences and interacting with digital content (e.g., images, videos, music, and the like). However, sharing social media/network content within virtual environments has various drawbacks. For example, maintaining the quality and security of virtual collaborations based on predefined boundary conditions according to a user’s preferences. Additionally, ensuring that virtual collaborations remain segmented and partitioned based on various factors such as the source/content of the digital content, the applicable social network platforms, sentiments, the given group of colleagues, etc. and the like. However, sharing metaverse content on social networks results in several challenges, including the need to efficiently gather, represent, and personalize user interactions from diverse social network channels. There's also a requirement to maintain quality and align the appended content with predefined boundary conditions, all while allowing flexible sharing during the collaboration's progress. The problem centers on improving user engagement, quality control, and the coherent presentation of metaverse content on social networking sites. Thus, the present embodiments have the capacity to allow users to generate privatized and/or secure virtual environments for sharing social network-based content by gathering interactions from social network users (e.g., comments, likes, shares, etc.) and append the aforementioned by creating a secure social-media zoning into a given virtual environment. Furthermore, the present embodiments improve the quality and security of social media content by filtering social media streams, interactions, etc. based on predefined policies, rules, preferences, etc. preventing unnecessary or inappropriate information from being integrated into the secure social-media zones. The aforementioned is performed in a manner that not only optimizes and privatizes the user’s virtual environment experience, but also reduces the amount of computing resources otherwise necessary to do so. In particular, by aggregating social media content across multiple platforms simultaneously in a scalable manner via segmenting the content based on the sentiments of the social network participants, demographic information of the social network users, and the like. This provides secure social-media zones segmented by visual extension boundaries, in which each secure social-media zone is operated by in accordance to its pre-defined policies in a scalable manner.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It is further understood that although this disclosure includes a detailed description on cloud-computing, implementation of the teachings recited herein are not limited to a cloud-computing environment. Rather, embodiments of the present invention are capable of being implemented in conjunction with any other type of computing environment now known or later developed.

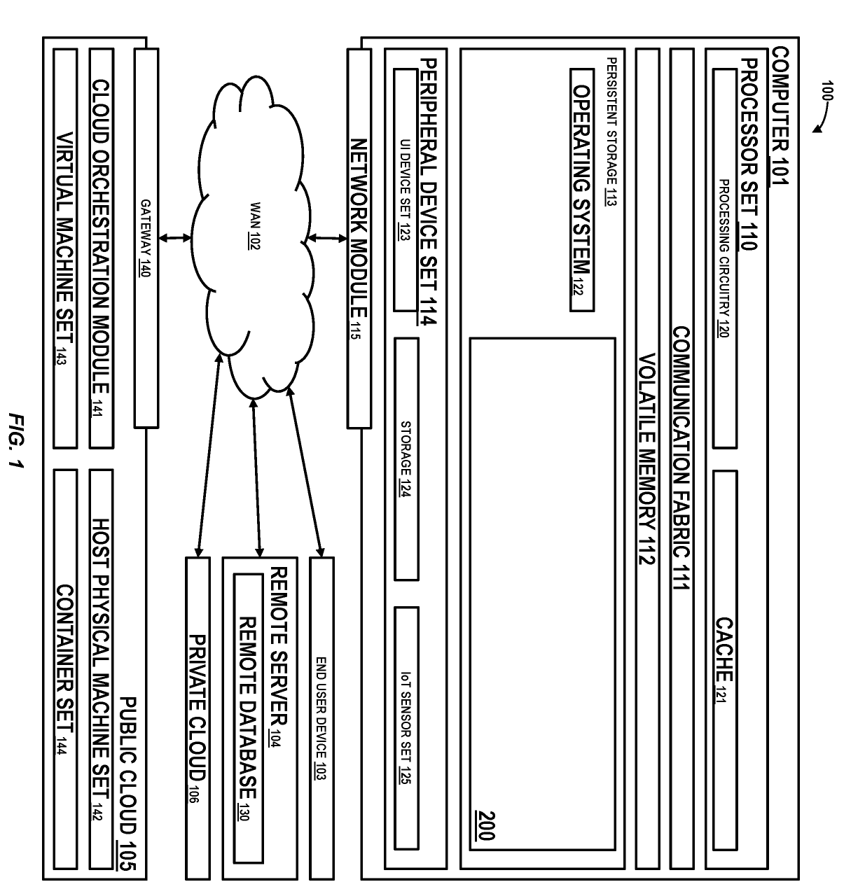

The following described exemplary embodiments provide a system, method, and computer program product for virtual environment-based obstacle manipulation. Referring now to FIG. 1, a computing environment 100 contains an example of an environment for the execution of at least some of the computer code involved in performing the inventive methods, such as system 200. In addition to system 200, computing environment 100 contains an example of an environment for the execution of at least some of the computer code involved in performing the inventive methods. Computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and system 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, computer-mediated reality device (e.g., AR/VR headsets, AR/VR goggles, AR/VR glasses, etc.), mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) payment device), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD payment device. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter payment device or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

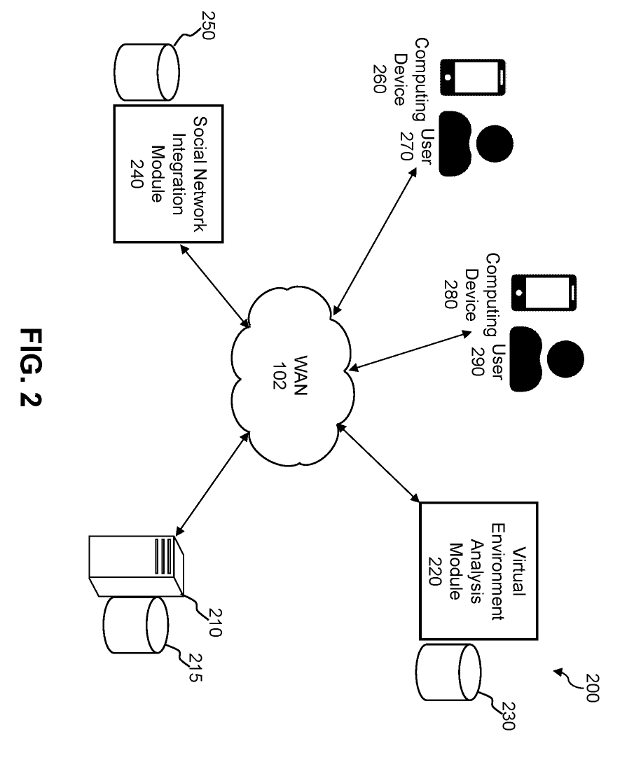

Referring now to FIG. 2, a functional block diagram of a networked computer environment illustrating a computing environment for a virtual environment-based obstacle manipulation system 200 (hereinafter “system”) comprising a server 210 communicatively coupled to a database 215, a virtual environment analysis module 220, a virtual environment analysis database 230, a social network integration module 240, a social network integration module database 250, a computing device 260 associated with a user 270, each of which are communicatively coupled over WAN 102 (hereinafter “network”) and data from the components of system 200 transmitted across the network is stored in database 215.

In some embodiments, server 210 is tasked with providing the platform configured to allow user 270 to not only provide a user profile and other applicable data pertaining to policies, criteria, preferences, etc. applied to facilitating secure social-media zoning, but also control aesthetic features of a visual extension boundary applied within a given virtual environment. It should be noted that the visual extension boundary allows a given virtual environment to be shared across various social network channels (e.g., Facebook®, LinkedIn ®, YouTube ®, etc.), in which users of the aforementioned platforms may interact with social media content in a partitioned manner. In some embodiments, the visual extension boundary segments the secure social-media zonings based on the applicable social network channel resulting in a series of secure social-media zonings simultaneously sharing their respective content in accordance with the applicable predefined rules, policies, and/or preferences of user 270. For example, user 270 may indicate that social media content for a first secure social-media zoning only comprises content suitable for children, social media content for a second secure social-media zoning only comprises content associated with a particular industry, and the like. As a result, subsets of users across the respective social network channels are integrated into the secure social-media zonings viewing and interacting with filtered social media content based on the predefined policies of the respective secure social-media zonings. Furthermore, the visual extension boundaries privatize the secure social-media zonings by preventing access and visibility to a first group of users from the first social network channel from a second group of users from a second social network channel without proper authorization.

Virtual environment analysis module 220 is configured to ascertain information associated with a given virtual environment in addition to predefined rules and preferences associated with user 270 and their application to the virtual environment. In some embodiments, virtual environment analysis module 220 is configured to not only analyze social media-based and other applicable profiles associated with user 270, but also ascertain information necessary to generate and maintain secure social-media zonings and visual extension boundaries such as but not limited to contextual information, secure social-media zonings criteria, social-network specific requirements, and the like. The aforementioned may be stored on social network integration module database 250. For example, contextual information may include, but is not limited to virtual environment venue, participant/avatar dialogue, time data (e.g., time of day, day of the week, etc.), event data associated with streaming social media content, biometrics of user 270 (e.g., heartrate, blood glucose levels, etc.), mood of user 270, electromyography, and any other applicable context-based data known to those of ordinary skill in the art. In some embodiments, virtual environment analysis module 220 utilizes contextual information, social media data derived from analyses of a user profile, and the like to define rules and policies for generating secure social-media zonings and visual extension boundaries stored in virtual environment analysis database 230. For example, in virtual environment analysis module 220 analyzing a given virtual environment, it may be ascertained that a secure social-media zoning may comprise one or more avatars that are associated minors/underage users; thus, resulting in filtration of social media content not suitable for children from a social media stream derived from a particular social network channel. In another example, user 270 may specify the desire for a secure social-media zoning to not comprise or integrate social media content comprising political or offensive content. Furthermore, virtual environment analysis module 220 may utilize image/video analysis, parsing, tokenizing, 3D point cloud segmentation, virtual object detection, theme identification, or any other applicable artificial intelligence-based and/or VR/AR-based analysis mechanisms known to those of ordinary skill in the art.

Social network integration module 240 is tasked with not only performing social media content filtration based on policies, rules, and preferences received from virtual environment analysis module 220, but also generating/maintaining secure social-media zonings and visual extension boundaries in which the secure social-media zonings comprise visual extension boundaries within the virtual environment configured to allow visualization and interaction with social media content. In some embodiments, if a first metaverse collaboration is shared on a social network then social network integration module 240 restricts social media interactions (e.g., comments, posts, etc.) from social network users that are outside the boundary conditions; thus, resulting in an appending or integrating within the virtual environment that aligns with the specified boundary conditions. Furthermore, social network integration module 240 is configured to use one or more machine learning models to not only predict restrictions for social media zonings, but also render visualizations of avatars configured to serve as audiences within secure social-media zonings. In some embodiments, the visualizations include but are not limited to audio cues (e.g., cheering, clapping, booing, etc.), displaying placards based on contextual information, body language (e.g., gestures, facial expressions, etc.), and any other avatar-based interactions designed to be manifested in a virtual environment known to those of ordinary skill in the art. In some embodiments, social network integration module 240 segments visual extension boundaries associated with a given virtual environment based on the applicable social network channel. The segmentation may be based on one or more of contextual information, user preferences, predefined rules/policies, viewing demographic, emotion/sentiment analyses of the applicable audience, and the like. It should be noted that social network integration module 240 allows either directional live sharing to the applicable social networking channels/sites or a sharing of the given virtual environment on an applicable social network site. Accordingly, social network integration module 240 integrates a first virtual environment in any direction or appends it from its entire visual extension boundary.

Computing devices 260 and 280 may take the form of a desktop computer, laptop computer, tablet computer, smart phone, smart watch or other wearable computer, mainframe computer, computer-mediated reality (CMR) device/VR device, quantum computer or any other form of computer or mobile device now known or to be developed in the future that is capable of running a program, accessing a network, or querying a database. It should be noted that in the instance in which computing device 260 is a CMR device (e.g., VR headset, AR goggles, smart glasses, etc.) or other applicable wearable device, computing device 260 is configured to collect sensor data via one or more associated sensor systems including, but are not limited to, cameras, microphones, position sensors, gyroscopes, accelerometers, pressure sensors, cameras, microphones, temperature sensors, biological-based sensors (e.g., heartrate, biometric signals, etc.), a bar code scanner, an RFID scanner, an infrared camera, a forward-looking infrared (FLIR) camera for heat detection, a time-of-flight camera for measuring distance, a radar sensor, a LiDAR sensor, a temperature sensor, a humidity sensor, a motion sensor, internet-of-things (“IOT”) sensors, or any other applicable type of sensors known to those of ordinary skill in the art. Furthermore, users 270 and 290 may be virtual environment participants operating on two distinct social networks/channels in which a first visual extension boundary is associated with user 270 and a second visual extension boundary is associated with user 290. In some embodiments, the first and second visual extension boundaries may overlap with a given virtual environment subject to predefined policies, criteria, user preferences, etc. being in accordance with each other.

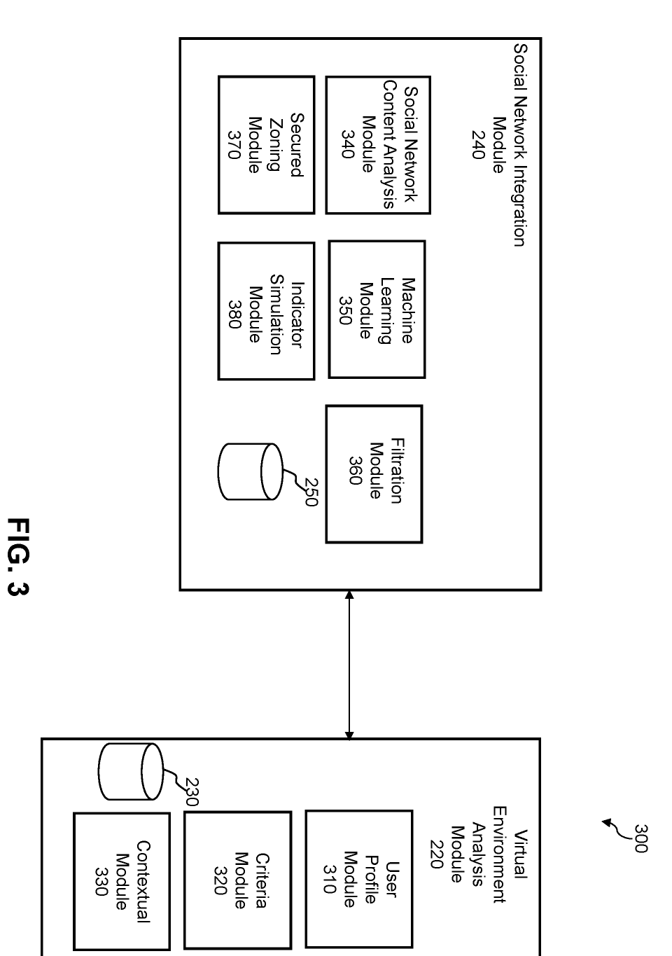

Referring now to FIG. 3, an example architecture 300 of virtual environment analysis module 220 and social network integration module 240 is depicted, according to an exemplary embodiment. Virtual environment analysis module 220 comprises a user profile module 310, a criteria module 320, and a contextual module 330. Social network integration module 240 comprises a social network content analysis module 340, a machine learning module 350, a filtration module 360, a secure zoning module 370, and an indicator simulation module 380. It should be noted that virtual environment analysis module 220 and social network integration module 240 are communicatively coupled over the network allowing for outputs and/or analyses performed by each respective module to be utilized in applicable training datasets to be utilized by applicable machine learning models operated by machine learning module 350 and/or applicable cognitive systems associated with system 200.

User profile module 310 is tasked with generating and maintaining user profiles associated with user 270 and any other applicable users operating on the centralized platform. It should be noted that a user profile may account for information associated with user 270 including but not limited to avatar behaviors, user preferences, interests, habits/routines, biological data subject to user authorization, user behavior data, user interaction data, user internet browsing-based data, social media-based data, and any other applicable user data known to those of ordinary skill in the art is continuously collected, analyzed, and updated. User profiles may also account for information derived from one or more internet-based sources associated with user 270 including but not limited social network channels, weather sources, politic/news outlets, and the like. In some embodiments, a user profile may account for analyses performed on sensor data acquired by computing device 260 such as, but not limited to biometrics, virtual interactions, eye tracking, virtual environment subject matter attention (e.g., user specific analytics), and the like. In some embodiments, the user profile is utilized by contextual module 330 in order to ascertain a sentiment/tone associated with a secure social-media zoning resulting in facilitation of a virtual environment in which the aggregation of the audience shares a consensus regarding the applicable social media content being depicted within the secure social-media zoning. For example, a certain social media post being interacted with by user 270 may relate to the subject of politics, in which user 270 may express a particular viewpoint resulting in the secure social-media zoning generating a visual extension boundary separating a first aggregation of an audience that agrees with the particular viewpoint from a second aggregation of an audience that disagrees with the particular viewpoint.

Criteria module 320 is tasked with establishing defining the policies, rules, preferences, etc. associated with generating the secure social-media zonings and applying the visual extension boundaries within secure social-media zonings. It should be noted that the criteria module 320 regulates the computational, security, social, and ethical requirements associated with the segmentation of a given virtual environment performed by social network integration module 240. In particular, segmentation of the visual extension boundaries is based on criteria module 320 defining criteria, in which the criteria may include but not limited to social network channels, sentiment analysis, demographic information, or any other applicable attributes of the social network users known to those of ordinary skill in the art. For example, criteria module 320 may ascertain demographic data from user profiles such as age, gender, location, and other applicable information, in which criteria module 320 leverages social network Application Programming Interfaces (APIs) to extract the aforementioned information. In some embodiments, criteria module 320 communicates with third-party data enrichment services in order to ascertain more granular demographics information.

Contextual module 330 is tasked with ascertaining contextual information associated with a virtual environment, the activities associated with avatars within the virtual environment (e.g., dialogue, gestures, sentiment, etc.), and/or social media content depicted within secure social-media zonings. In some embodiments, contextual module 330 analyzes virtual environment elements (e.g., avatars, chatbots, setting, theme, virtual objects, etc.), dialogue/linguistic inputs, topics/sentiments of social media content, and any other applicable information ascertained from virtual environments and social network channels known to those of ordinary skill in the art. As described herein, contextual information may include, but is not limited to, relevant information associated with the geographic location of user 270 (e.g., weather, traffic, politics, laws/ordinances, etc.), topic/subject matter, virtual environment sentiments/moods, date/time of day, environment/virtual object theme/setting, habits/routines, preferences, participant dialogue concept, an event within the virtual environment (e.g., E-sport, dining experience, E-concert, shopping experience, etc.), occurrences of a predetermined pattern of user 270, activities thereof within the virtual environment, or any other applicable contextual-based data known to those of ordinary skill in the art. Contextual module 330 comprises natural language processing (NLP), image analysis, topic identification, virtual object recognition, setting/environment classification, and any other applicable artificial intelligence and/or cognitive-based techniques known to those of ordinary skill in the art. It should be noted that ascertaining contextual information is imperative for generating secure social-media zonings and applying the visual extension boundaries within secure social-media zonings due to the fact that contextual information assists with determining whether criteria for a secure social media zoning has been met. For example, contextual module 330 may utilize natural language processing (NPL) perform sentiment analyses on a given virtual environment along with the social media content user 270 is attempting to integrate into an applicable secure social media zoning, in which the classification of sentiment (e.g., negative, positive, neutral, etc.) may dictate the allocation of visual extension boundaries. In the application of visual extension boundaries to the secure social-media zoning based on sentiment classification, social network content analysis module 340 is able to perform mapping of user profiles with the social media content users generate and/or interact with; thus, resulting in optimized user sentiment tracking and demographic-based trends across various periods of time.

Social network content analysis module 340 is configured to continuously track and monitor streaming feeds of social network channels. In some embodiments, social network content analysis module 340 utilizes one or more pre-defined policies, user preferences, parental controls, stream intents from previous streams, semantic explicit filter rules, demographic analyses, user profiles, and the like to perform real-time classifications of social media content. Furthermore, social network content analysis module 340 may utilize natural language processing and/or other applicable machine learning-based techniques to identify sentiment and/or intensity of social media content. In some embodiments, classifications are based on user inputs, training a model, real-time observations of a user, other machine learning techniques, or some combination of such techniques. For example, social network content analysis module 340 communicates with machine learning module 350 to analyze how long user 270 interacts with a particular social media content or which social media content user 270 hides to assist filtration module 360 to determine appropriate filtering preferences. In some embodiments, classifications may be based on one or more of linguistic analyses, statistical analyses, object/person identification, and the like resulting in ascertaining sentiment, topic, target demographic, and the like. In some embodiments, sentiment is scored based on the intensity ascertained from not only content of linguistic inputs but also facial expressions/body movements in reaction to social media content, body gestures, biological information (e.g., derived from computing device 260), biometrics, and the like. The scoring intensity not only assists with classification of the social media content, but also assists with increasing the accuracy for demographic-based predictions for audiences integrated into secure social-media zonings. In addition, social network content analysis module 340 is further configured to generate social media content analytics based on the processing of social network channel streams in order to ascertain the volume of social network interactions (e.g., posts, comments, likes) along with the number of users engaging with the social media content in real-time, in which analytics are stored as metadata for reference by the modules disclosed throughout.

Machine learning module 350 is configured to use one or more heuristics and/or machine learning models for performing one or more of the various aspects as described herein (including, in various embodiments, the natural language processing or image analysis discussed herein). In some embodiments, the machine learning models may be implemented using a wide variety of methods or combinations of methods, such as supervised learning, unsupervised learning, temporal difference learning, reinforcement learning and so forth. Some non-limiting examples of supervised learning which may be used with the present technology include AODE (averaged one-dependence estimators), artificial neural network, back propagation, Bayesian statistics, naive bays classifier, Bayesian network, Bayesian knowledge base, case-based reasoning, decision trees, inductive logic programming, Gaussian process regression, gene expression programming, group method of data handling (GMDH), learning automata, learning vector quantization, minimum message length (decision trees, decision graphs, etc.), lazy learning, instance-based learning, nearest neighbor algorithm, analogical modeling, probably approximately correct (PAC) learning, ripple down rules, a knowledge acquisition methodology, symbolic machine learning algorithms, sub symbolic machine learning algorithms, support vector machines, random forests, ensembles of classifiers, bootstrap aggregating (bagging), boosting (meta-algorithm), ordinal classification, regression analysis, information fuzzy networks (IFN), statistical classification, linear classifiers, fisher's linear discriminant, logistic regression, perceptron, support vector machines, quadratic classifiers, k-nearest neighbor, hidden Markov models and boosting, and any other applicable machine learning algorithms known to those of ordinary skill in the art. Some non-limiting examples of unsupervised learning which may be used with the present technology include artificial neural network, data clustering, expectation-maximization, self-organizing map, radial basis function network, vector quantization, generative topographic map, information bottleneck method, IBSEAD (distributed autonomous entity systems based interaction), association rule learning, apriori algorithm, eclat algorithm, FP-growth algorithm, hierarchical clustering, single-linkage clustering, conceptual clustering, partitional clustering, k-means algorithm, fuzzy clustering, and reinforcement learning. Some non-limiting examples of temporal difference learning may include Q-learning and learning automata. Specific details regarding any of the examples of supervised, unsupervised, temporal difference or other machine learning described in this paragraph are known and are considered to be within the scope of this disclosure. For example, machine learning module 350 is designed to maintain one or more machine learning models dealing with training datasets including data derived from database 215, virtual environment analysis database 230, and social network integration module database 250, in which the one or more machine learning models generate outputs representing predictions relating to contextual information, sentiment (e.g., social media content, user, audience consensus, etc.), secure social-media zoning policies/restrictions, user preferences, social media content targeted demographic, virtual environment template (e.g., theme, venue, avatars, etc.), and the like.

Filtration module 360 is tasked with filtering social media content ultimately integrated into the secure social-media zonings. It should be noted that the filtration of social media content may be based on one or more of pre-defined policies, applicable social network channel, user preferences, contextual information, detected sentiment, user profile analyses, geographic location of users, and the like. In some embodiments, filtration module 360 performs filtration of social media content based on thresholds derived from one or more of analyses of user profiles, user past behavior (e.g., previously disliked social media content), gestures indicating disinterest (e.g., body/facial movements, etc.), and the like. Thus, if a particular social media content exceeds the applicable threshold, then the social media content is filtered out and prevented from being integrated into a secure social-media zoning. For example, if user 270 repeatedly hides, minimizes, quickly skims or provides another indication of disinterest in a particular social media content then both that and similarly classified social media content will be filtered out from integration into a secure social-media zoning. Social media content is also filtered based on overall relevance to user 270, comment filters (e.g., offensive language, political content), interaction rules (e.g., likes and shares restrictions), audience restrictions (e.g., location, etc.), sentiment analysis settings, and the like. Filtration module 360 is further configured to perform social media interaction manipulation (e.g., comment redaction, object/entity occlusion, vocal manipulation, etc.) in real-time within the secure social-media zonings in order to enforce the pre-defined policies, user preferences, and overall social security within the given virtual environment. For example, comments within a given secure social-media zoning reflecting offensive language will automatically be redacted or concealed to prevent being viewed by the audience and/user 270.

Secure zoning module 370 is tasked with generating the secure social-media zonings along with applying the visual extension boundaries within. It should be noted that the social-media zonings may be generated by utilizing generative adversarial networks or any other applicable artificial intelligence-based techniques, in which the secure social-media zonings are partitions of a given virtual environment divided by visual extension boundaries. In some embodiments, the visual extension boundaries are applied based on the applicable social network channel the users or social media content is derived from, in which each social-media zoning comprises a different social media content derived from a different social network channel respectively. Each social-media zoning may comprise a distinct audience of avatars configured to visualize and vocalize various indicators rendered by indicator simulation module 380. It should be noted that secure zoning module 370 dynamically creates visual extension boundaries within the virtual environment for appending social network users' avatars and interactions, in which secure zoning module 370 utilizes rendering techniques to visually represent interactions in the appended virtual environment. A social-media zoning may comprise rules for segmenting the visual boundaries based on social network channel-specific segments resulting in optimized security and quality control for social media content.

Indicator simulation module 380 is tasked with generating the visual and audio content (e.g., simulated indicators, etc.) associated with audiences for a social-media zoning comprising visual extension boundaries. It should be noted that the indicator simulation module 380 creates simulated indicators to simulate audience participation and ensure consistency with the virtual environment which may include but is not limited to suitable avatar facial expressions, body language/gestures of the avatars, virtual objects comprised by the avatars (e.g., displaying placards, noisemakers, etc.), audio cues (e.g., clapping, cheering, booing, etc.), and the like. In some embodiments, indicator simulation module 380 renders the simulated indicators based on sentiment analyses performed on one or more of the social media content, social-media zoning, sensor data derived from applicable computing devices of avatar users, etc. Indicator simulation module 380 may receive mappings of social network users’ interactions with social media content, in which each avatar should correspond to a particular user's engagement. This allows indicator simulation module 380 to generate personalized simulated indicators based on a given avatar’s interaction with a particular social media content within the secure social-media zoning. For example in response to a presented social media content associated with a secure social-media zoning of user 270, user 290 may post a comment in which indicator simulation module 380 generates and displays the comment as a placard or speech bubble near the associated avatar's location in the virtual environment, and indicator simulation module 380 may also utilize visual cues to make these simulated indicators stand out (e.g., flashing, strobing, interactive virtual objects, etc.).

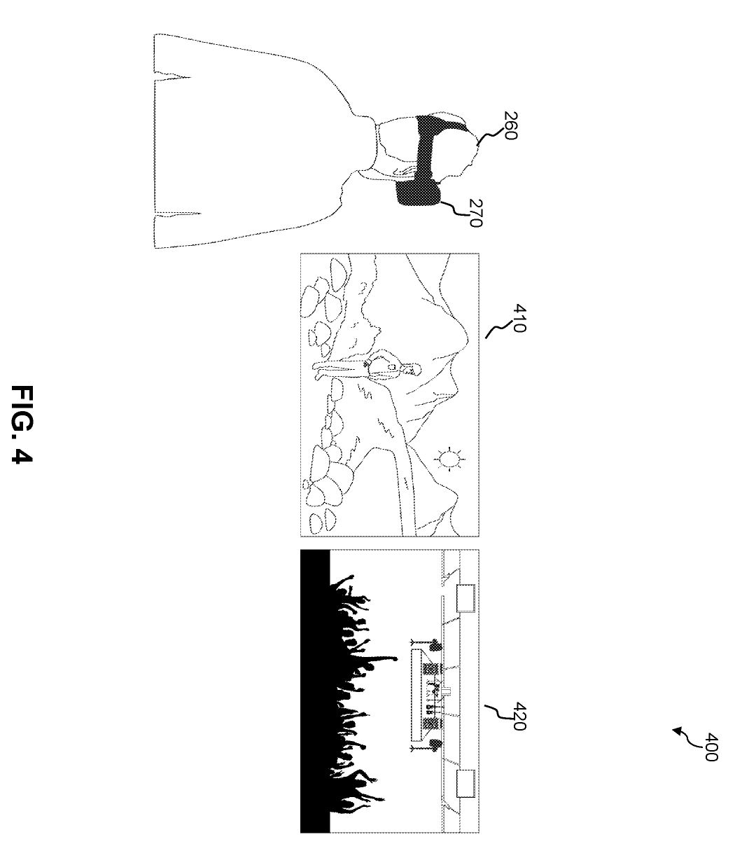

Referring now to FIG. 4, a viewpoint 400 of user 270 in a virtual environment viewing a first streaming event 410 of a first social network channel and a second streaming event 420 of a second social network channel is depicted, according to an exemplary embodiment. In some embodiments, first streaming event 410 functions as a designated secure social-media zoning for the first social network channel and second streaming event 420 functions as a designated secure social-media zoning for the second social network channel. Social network integration module 240 continuously monitors social network channels for new social media content and user interactions, in which social network integration module 240 perform real-time analysis to not only keep demographic and sentiment data up to date, but also enforce the pre-defined rules across the visual extension boundaries. In some embodiments, different secure social-media zones can be designated for specific segments of users. For example, first streaming event 410 and second streaming event 420 may be segmented based on different identified themes/venues.

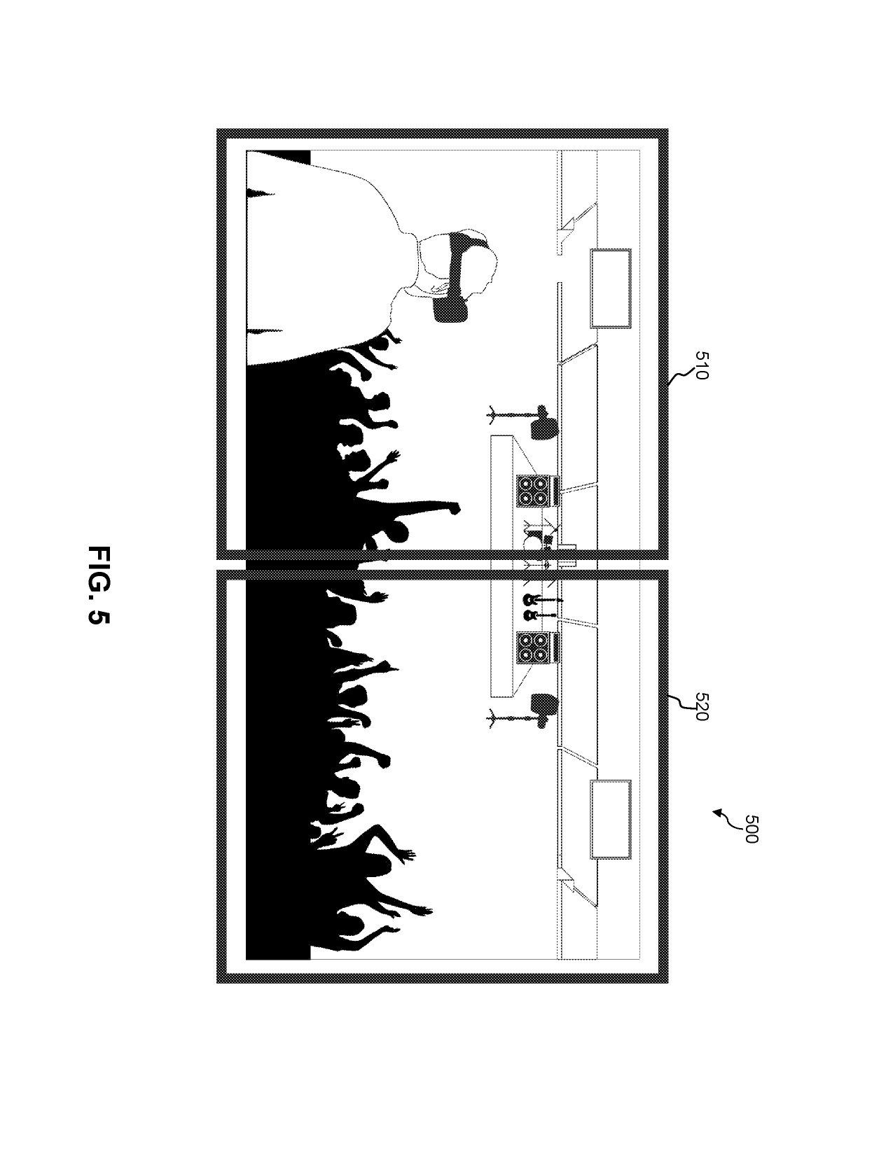

Referring now to FIG. 5, a virtual environment 500 comprising a first secure social-media zoning 510 and a second secure social-media zoning 520 is depicted, according to an exemplary embodiment. It should be noted that secure social-media zonings 510 and 520 are generated based on analyses of one or more of contextual information (e.g., sentiment, age group, etc.), user profiles, social network channel, social media content, and the like. As a result, the expanded visual boundaries are segmented and applied resulting in social media interactions from social network users of the respective zoning being restricted from each other. In some embodiments, presentation of a given social media content is either directional live sharing to a social networking channel or a complete sharing of virtual environment 500 on a social network site. Accordingly, virtual environment 500 is appended in any direction or append from its entire boundary. Thus, based upon the predetermined rules, the avatars of participants from the respective social network channels will be shown in appended virtual environment 500.

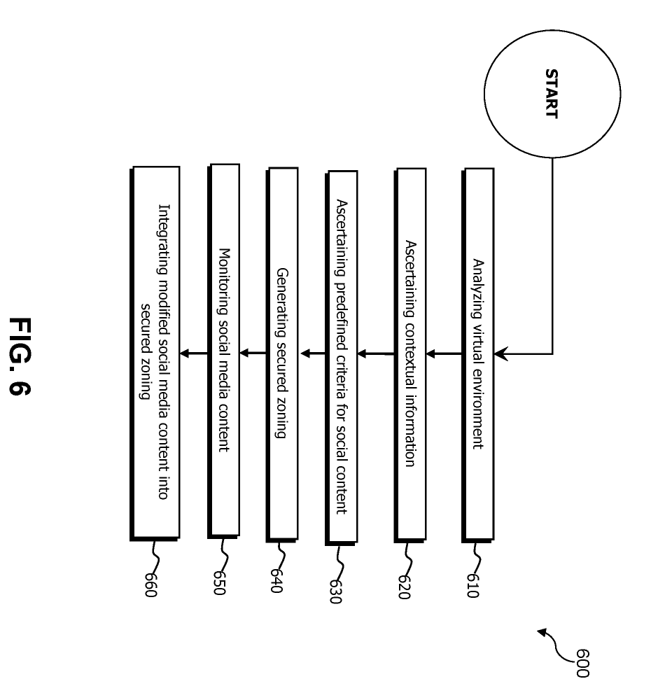

With the foregoing overview of the example architecture, it may be helpful now to consider a high-level discussion of an example process. FIG. 6 depicts a flowchart illustrating a computer-implemented process 600 for sharing social media-based virtual environment collaborations, consistent with an illustrative embodiment. Process 600 is illustrated as a collection of blocks, in a logical flowchart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform functions or implement abstract data types. In each process, the order in which the operations are described is not intended to be construed as a limitation, and any number of the described blocks can be combined in any order and/or performed in parallel to implement the process.

At step 610 of process 600, virtual environment analysis module 220 analyzes a given virtual environment associated with computing device 260 and/or user 270. Virtual environment analysis module 220 may utilize one or more artificial intelligence-based mechanisms including, but not limited to computer vision, image analysis, natural language/linguistics processing, topic identification, virtual object recognition, setting/environment classification, and any other applicable virtual/augmented reality-based analysis techniques known to those of ordinary skill in the art. In some embodiments, virtual environment analysis module 220 communicates with computing device 260 in order to acquire sensor data from one or more sensor systems, the one or more sensor systems including, but not limited to cameras, microphones, position sensors, gyroscopes, accelerometers, pressure sensors, cameras, microphones, temperature sensors, biological-based sensors (e.g., heartrate, biometric signals, etc.), a bar code scanner, an RFID scanner, an infrared camera, a forward-looking infrared (FLIR) camera for heat detection, a time-of-flight camera for measuring distance, a radar sensor, a LiDAR sensor, a temperature sensor, a humidity sensor, a motion sensor, internet-of-things (“IOT”) sensors, or any other applicable type of sensors known to those of ordinary skill in the art. It should be noted that analyses of a given virtual environment is necessary for not only acquiring information relating to the given virtual environment (e.g., venue, theme, virtual objects, etc.), but also to assist with ascertaining contextual information, social network channel source for social media content, and the like.

At step 620 of process 600, contextual module 330 ascertains context associated with the given virtual environment. As previously mentioned, contextual module 330 is tasked with ascertaining contextual information associated with a virtual environment and the social media content of the applicable social network channel. In some embodiments, contextual module 330 analyzes virtual environment elements (e.g., setting, theme, virtual objects, etc.), social media content sentiment, social media network information, news/politics, weather, and any other applicable information relevant to the geographic location or virtual environment location of the user 270 known to those of ordinary skill in the art. Furthermore, contextual information may include, but is not limited to, relevant information associated with the geographic location of user 270 (e.g., weather, traffic, politics, laws/ordinances, etc.), topic/subject matter, virtual environment sentiments/moods, date/time of day, environment/virtual object theme/setting, habits/routines, preferences, participant dialogue concept, an event within the virtual environment (e.g., E-sport, dining experience, E-concert, shopping experience, etc.), occurrences of a predetermined pattern of user 270, activities thereof within the virtual environment, or any other applicable contextual-based data known to those of ordinary skill in the art.

At step 630 of process 600, criteria module 320 ascertains predefined criteria for social media content. In some embodiments, the predefined criteria is derived from analyses of user profiles, ascertained contextual information, user preferences, social network channel-specific factors, etc. Criteria module 320 utilizes the criteria to define the policies, rules, preferences, etc. associated with generating the secure social-media zonings and applying the visual extension boundaries within secure social-media zonings. It should be noted that the criteria module 320 regulates the computational, security, social, and ethical requirements associated with the segmentation of a given virtual environment performed by social network integration module 240. In particular, segmentation of the visual extension boundaries is based on criteria module 320 defining criteria, in which the criteria may include but not limited to social network channels, sentiment analysis, audience demographic information, or any other applicable attributes of the social media content and/or social network users known to those of ordinary skill in the art.

At step 640 of process 600, secured zoning module 370 generates secured social media zonings. In some embodiments, the visual extension boundaries are applied within the social-media zonings based on the predefined criteria. It should be noted that the social-media zonings may be generated by utilizing generative adversarial networks or any other applicable artificial intelligence-based techniques, in which the secure social-media zonings are partitions of a given virtual environment divided by visual extension boundaries based on one or more of user profile analyses, contextual information, audience demographic, social network channel, social media content sentiment, and the like. The visual extension boundaries may be applied in a manner in which the social media content, secured social media zoning audience, and/or social media content-based interactions of a first secure social media zoning are not visible to a second secure social media zoning.

At step 650 of process 600, filtration module 360 performs monitoring of social media content. It should be noted that one of the purposes of monitoring social media content is to perform filtration of social media content that does not align with the predefined policies, criteria, user preferences, etc. applied to a given secure social media zoning. Filtration module 360 performs filtration of social media content based on thresholds derived from one or more of analyses of user profiles, user past behavior (e.g., previously disliked social media content), gestures indicating disinterest (e.g., body/facial movements, etc.), and the like. Thus, if a particular social media content exceeds the applicable threshold then the social media content is filtered out and prevented from being integrated into a secure social-media zoning. Social media content may also be filtered out based on applicable social network channel, secure social media zoning audience sentiment, audience demographic information, and the like.

At step 660 of process 600, social network integration module 240 integrates modified social media content into secure social media zonings. It should be noted that one or more social networking channels/platforms along with their respective users are selected for integration into the secure social-media zoning based on the predefined criteria. During the integration, social network integration module 240 prevents/restricts social media content interactions (e.g., comments, posts, etc.) from social network users that are outside the predefined rules; thus, resulting in an appending or integrating within the virtual environment that aligns with the specified criteria. In some embodiments, social network integration module 240 utilizes one or more machine learning models to not only predict restrictions for social media zonings, but also render visualizations and audio content of avatars that serve as audiences within secure social-media zonings. The visualizations include but are not limited to displaying placards based on contextual information, body language (e.g., gestures, facial expressions, etc.), and any other avatar-based interactions designed to be manifested in a virtual environment known to those of ordinary skill in the art. Segmentation by the visual extension boundaries may be based on the applicable social network channel. The segmentation may be based on one or more of contextual information, user preferences, predefined rules/policies, viewing demographic, emotion/sentiment analyses of the applicable audience, and the like. Social network integration module 240 allows either directional live sharing to the applicable social networking channels/sites or a sharing of the given virtual environment on an applicable social network site.

Based on the foregoing, a method, system, and computer program product have been disclosed. However, numerous modifications and substitutions can be made without deviating from the scope of the present invention. Therefore, the present invention has been disclosed by way of example and not limitation.

The terminology used herein is for the purpose of describing particular embodiments only and is not intended to be limiting of the invention. As used herein, the singular forms "a," "an," and "the" are intended to include the plural forms as well, unless the context clearly indicates otherwise. It will be further understood that the terms "comprises," "comprising," "includes," "including," "has," "have," "having," "with," and the like, when used in this specification, specify the presence of stated features, integers, steps, operations, elements, and/or components, but does not preclude the presence or addition of one or more other features, integers, steps, operations, elements, components, and/or groups thereof.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-payment devices or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g. light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter payment device or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

It will be appreciated that, although specific embodiments have been described herein for purposes of illustration, various modifications may be made without departing from the spirit and scope of the embodiments. In particular, transfer learning operations may be carried out by different computing platforms or across multiple devices. Furthermore, the data storage and/or corpus may be localized, remote, or spread across multiple systems. Accordingly, the scope of protection of the embodiments is limited only by the following claims and their equivalent.

What is claimed is:

1. A computer-implemented method for sharing social media-based virtual environment collaboration, the method comprising:
analyzing, by a computing device, a virtual environment;
determining, by the computing device, a plurality of contextual information and a secure social-media zoning associated with the virtual environment based on the analysis; and
presenting, by the computing device, the virtual environment to a social media network associated with a user based on the secure social-media zoning;
wherein the secure social-media zoning comprises an audience comprising a derivative of the social media network.

2. The computer-implemented method of claim 1, wherein the secure social-media zoning comprises a visual extension boundary within the virtual environment comprising a visualization of one or more social media interactions associated with the social media network.

3. The computer-implemented method of claim 1, wherein the social media network may comprise one or more social networking platforms and one or more social networking platform users are selected for integration into the secure social-media zoning based on one or more predefined rules.

4. The computer-implemented method of claim 2, wherein presenting the virtual environment comprises segmenting the secure social-media zoning based on at least one social media network analytic derived from the social media network.

5. The computer-implemented method of claim 3, wherein the one or more predefines rules prevent integration of one or more social media interactions and users into the virtual environment.

6. The computer-implemented method of claim 1, wherein presenting the virtual environment comprises simulating one or more gestures, audio indicators, and visual indicators within the audience.

7. The computer-implemented method of claim 1, wherein the virtual environment is live-streamed on the social media network comprising the secure social-media zoning.

8. A computer program product for sharing social media-based virtual environment collaboration, the computer program product comprising or more computer readable storage media and program instructions collectively stored on the one or more computer readable storage media, the stored program instructions comprising:
program instructions to analyze a virtual environment;
program instructions to determine a plurality of contextual information and a secure social-media zoning associated with the virtual environment based on the analysis; and
program instructions to present the virtual environment to a social media network associated with a user based on the secure social-media zoning;
wherein the secure social-media zoning comprises an audience comprising a derivative of the social media network.

9. The computer program product of claim 8, wherein the secure social-media zoning comprises a visual extension boundary within the virtual environment comprising a visualization of one or more social media interactions associated with the social media network.

10. The computer program product of claim 8, wherein the social media network may comprise one or more social networking platforms and one or more social networking platform users are selected for integration into the secure social-media zoning based on one or more predefined rules.

11. The computer program product of claim 9, wherein program instructions to present the virtual environment comprise program instructions to segment the secure social-media zoning based on at least one social media network analytic derived from the social media network.

12. The computer program product of claim 10, wherein the one or more predefines rules prevent integration of one or more social media interactions and users into the virtual environment.

13. The computer program product of claim 8, wherein program instructions to present the virtual environment comprises simulating one or more gestures, audio indicators, and visual indicators within the audience.

14. The computer program product of claim 8, wherein the virtual environment is live-streamed on the social media network comprising the secure social-media zoning.

15. A computer system for sharing social media-based virtual environment collaboration, the computer system comprising:
one or more processors;
one or more computer-readable memories;
program instructions stored on at least one of the one or more computer-readable memories for execution by at least one of the one or more processors, the program instructions comprising:
program instructions to analyze a virtual environment;
program instructions to determine a plurality of contextual information and a secure social-media zoning associated with the virtual environment based on the analysis; and
program instructions to present the virtual environment to a social media network associated with a user based on the secure social-media zoning;
wherein the secure social-media zoning comprises an audience comprising a derivative of the social media network.

16. The computer system of claim 15, wherein the secure social-media zoning comprises a visual extension boundary within the virtual environment comprising a visualization of one or more social media interactions associated with the social media network.

17. The computer system of claim 15, wherein the social media network may comprise one or more social networking platforms and one or more social networking platform users are selected for integration into the secure social-media zoning based on one or more predefined rules.

18. The computer system of claim 16, wherein program instructions to present the virtual environment comprise program instructions to segment the secure social-media zoning based on at least one social media network analytic derived from the social media network.

19. The computer system of claim 15, wherein program instructions to present the virtual environment comprises simulating one or more gestures, audio indicators, and visual indicators within the audience.

20. The computer system of claim 15, wherein the virtual environment is live-streamed on the social media network comprising the secure social-media zoning.
